(19) United States
(12) Patent Application Publication
(10) Pub. No.: US 2017/0059071 A1
(43) Pub. Date: Mar. 2, 2017

(54) PIPE CONNECTOR FOR CONNECTING A FUEL LINE OF A FUEL SUPPLY FOR A MOTOR VEHICLE ENGINE

(71) Applicant: Dr. Ing. h.c. F. Porsche Aktiengesellschaft, Stuttgart (DE)

(72) Inventors: Kai Podewski, Pforzheim (DE); Andreas Menke, Vaihingen a.d.Enz/Enzweihingen (DE)

(21) Appl. No.: 15/243,990

(22) Filed: Aug. 23, 2016

(30) Foreign Application Priority Data
Aug. 26, 2015 (DE) 10 2015 114 116.7

(51) Int. Cl. F16L 33/207

(52) U.S. Cl. CPC F16L 33/2076

(57) ABSTRACT

A pipe connector is for connecting a fuel line of a fuel supply for a motor vehicle engine of a motor vehicle. The pipe connector has a coupling element that includes a metallic material and is configured to connect to the fuel line, where the fuel line includes a synthetic material. The coupling element includes a pipe projection configured for clamping insertion into the fuel line and a retaining collar for radially externally surrounding the fuel line. An extent of the retaining collar in an axial direction and a distance between the retaining collar and pipe projection is selected so as to limit swelling of the fuel line.

### CROSS REFERENCE TO RELATED APPLICATIONS

Priority is claimed to German Patent Application No. DE 10 2015 114 116.7, filed on Aug. 26, 2015, the entire disclosure of which is hereby incorporated by reference herein.

### FIELD

The invention relates to a pipe connector, with the aid of which a fuel line as part of a fuel supply can be connected to a motor vehicle engine of a motor vehicle.

### BACKGROUND

DE 94 08 147 U1 discloses a coupling element for connecting a fuel line, in which a latching profile, configured as a fir-tree profile, can be embedded into the material of the fuel line, and a sealing ring can be squashed between the axially oriented end faces of the coupling element and of the fuel line.

It is always beneficial to reduce egress of hydrocarbons from a fuel supply of a motor vehicle.

### SUMMARY

In an embodiment, the present invention provides a pipe connector for connecting a fuel line of a fuel supply for a motor vehicle engine of a motor vehicle. The pipe connector has a coupling element that includes a metallic material and is configured to connect to the fuel line, where the fuel line includes a synthetic material. The coupling element includes a pipe projection configured for clamping insertion into the fuel line and a retaining collar for radially externally surrounding the fuel line. An extent of the retaining collar in an axial direction and a distance between the retaining collar and pipe projection is selected so as to limit swelling of the fuel line.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic sectional view of a pipe connector; and

FIG. 2 shows a schematic sectional view of a pipe connector system with the pipe connector from FIG. 1.

### DETAILED DESCRIPTION

In an embodiment, the present invention provides measures which permit limited egress of hydrocarbons from a fuel supply of a motor vehicle.

In an embodiment, the present invention provides a pipe connector for connecting a fuel line of a fuel supply for a motor vehicle engine of a motor vehicle, with a coupling element made of a metallic material for connecting to the fuel line made of a synthetic material, wherein the coupling element has a pipe projection for clamping insertion into the fuel line and a retaining collar for radially externally surrounding the fuel line, wherein the extent of the retaining collar in the axial direction and the radial distance between the retaining collar and the pipe projection are chosen to limit swelling of the fuel line.

This uses the knowledge that a fuel line made of a polyolefin such as polyethylene (“PE”) can swell on contact with aliphatic and/or aromatic hydrocarbons, as are typically found in fuels for internal combustion engines. Since the metallic coupling element of the pipe connector does not swell on contact with the fuel, it is possible for a gap to develop between the pipe projection of the metallic coupling element and the swollen fuel line, and/or for a sealing effect to decrease, such that in particular gaseous hydrocarbons of the conveyed fuel can escape. However, the retaining collar running in particular coaxially radially outside the pipe projection can present a barrier to a swelling motion of the fuel line. The retaining collar can prevent the fuel line from lifting off from the pipe projection. Since the swelling fuel line is held by the retaining collar, the fuel line in the region of the retaining collar can move only radially within the retaining collar as a consequence of the volume increase due to the swelling. It is thus possible, as the case may be, for free volumes between the retaining collar and the pipe projection to be filled and/or for a radial contact force between the fuel line and the pipe projection to be increased. It is thus possible, with the aid of the retaining collar, for the sealing effect between the fuel line and the pipe projection to not only not be reduced, but even to be improved in the event of the fuel line swelling. The retaining collar makes it possible to avoid the fuel line lifting radially off from the pipe projection when the fuel line swells due to the conveyed fuel, so as to permit limited egress of hydrocarbons from a fuel supply of a motor vehicle.

It can be provided that the coupling element can be connected, at the axial end oriented away from the fuel line, to another fuel line, such that it is possible, with the aid of the pipe connector, to couple two fuel lines to one another. The retaining collar and the pipe projection are in particular configured in one piece from the metallic material of the coupling element. The material of the coupling element can form, in the radial region between the retaining collar and the pipe projection, an annular end stop for an axially oriented end face of the fuel line. The end stop makes it possible to predefine a defined overlap of the retaining collar on the fuel line at maximum insertion depth of the fuel line into a receiving pocket bounded by the retaining collar, the pipe projection and the end stop. This makes it easy to select a suitable axial extent for the retaining collar which blocks swelling in a sufficiently large axial section of the fuel line, in order to ensure adequate sealing effect. For example, the retaining collar has, proceeding from the end face of the end stop, an axial extent a which, relative to the external diameter D of the pipe projection in the axial region of the retaining collar that corresponds essentially to the nominal internal diameter of the fuel line, is such that 0.25≦a/D≦0.50 in particular 0.30≦a/D≦0.40 and preferably a/D=0.35±0.02. A fit, preferably a press fit, is preferably formed between the minimum internal diameter of the retaining collar and the nominal external diameter of the un-swollen fuel line. For example, a distance b between the minimum internal diameter of the retaining collar and the external diameter D of the pipe projection is such that 0.01≦b/D≦0.20, in particular 0.02≦b/D≦0.10, preferably 0.05≦b/D≦0.08 and very particularly 0.06≦b/D≦0.07. Depending on the wall thickness of the fuel line to be connected and/or on the swelling capacity of the fuel line, it is however also possible to select markedly different values for b/D.

In particular, the retaining collar has, facing the pipe projection, a deformable outer sealing element, in particular a sealing ring, for bearing against the radially outer side of the in particular un-swollen fuel line. The outer sealing element can develop a sufficient sealing effect on the outer side of the fuel line, which can prevent egress of gaseous hydrocarbons. Particularly preferably, the corresponding sealing effect that can be provided by the outer sealing element is achieved only in the swollen state of the fuel line. Thus, during fitting in the un-swollen state, the fuel line can easily be plugged onto the pipe projection and plugged into the retaining collar without the outer sealing element causing increased resistance. Only in the swollen state of the fuel line is the outer sealing element pressed with an accordingly high contact force against the outer side of the fuel line, in order to provide the necessary sealing effect. Alternatively, the outer sealing element can provide the desired sealing effect already in the un-swollen state of the fuel line.

Preferably, the retaining collar has a circumferential receiving groove, which is open towards the pipe projection, for receiving the outer sealing element. The outer sealing element can be made of a different material to the retaining collar, for example a rubber-elastic material. The receiving groove allows the outer sealing element to be inserted so far into the receiving groove that, during fitting of the fuel line, the outer sealing element is not carried off in the axial direction by an end face of the fuel line. The outer sealing element can thus be positioned reliably at the intended axial location of the retaining collar, and remain there.

Particularly preferably, the outer sealing element forms the smallest internal diameter of the retaining collar. When the fuel line swells, this generates the highest contact force, and thus the best sealing effect, in the region of the outer sealing element. In addition, the outer sealing element can embed itself in the material of the swollen fuel line, resulting in an accordingly more solid assembly in the swollen state of the fuel line.

In particular, the retaining collar has an insertion chamfer for inserting the fuel line between the pipe projection and the retaining collar. The fuel line can thus be more easily inserted into the retaining collar. In addition, this allows the outer sealing element to be easily provided at the location of the smallest internal diameter of the retaining collar.

Preferably, the pipe projection has a radially outward-facing latching profile, in particular configured as a fir-tree profile, for embedding into the material of the fuel line. It is thus possible to prevent the fuel line from slipping axially off the pipe projection, in particular in the event of elevated fuel pressure.

Particularly preferably, the latching profile is formed offset in the axial direction with respect to that part region of the pipe projection which is overlapped in the radial direction by the retaining collar. This makes it possible to prevent the fuel line radially inside the retaining collar being pressed radially outward by the latching profile. This facilitates insertion of the fuel line into the retaining collar or, in the case of a suitably tight fit, makes this possible in the first place.

In particular, the pipe projection has, facing the retaining collar, a deformable inner sealing element, in particular a sealing ring, for bearing against the radially inner side of the fuel line. It is thus possible to establish, even in the un-swollen state of the fuel line, an adequate seal between the coupling element of the pipe connector and the fuel line.

The invention also relates to a pipe connection system for the fuel supply of a motor vehicle engine, with a pipe connector, which can be formed and refined as described above, and a fuel line made of a polyolefin, in particular polyethylene, wherein the fuel line is plugged in between the pipe projection of the pipe connector and the retaining collar of the pipe connector. The retaining collar of the pipe connector makes it possible to avoid the fuel line lifting radially off from the pipe projection when the fuel line swells due to the conveyed fuel, so as to permit limited egress of hydrocarbons from a fuel supply of a motor vehicle.

In particular, the retaining collar, in particular the outer sealing element, is partially embedded in the material of the un-swollen and/or swollen fuel line. This allows the retaining collar to engage in the material of the fuel line with a solid and/or deformable part, such that it is possible to avoid the fuel line slipping off the coupling element.

Below, the invention will be discussed by way of example with reference to the appended drawings and on the basis of preferred exemplary embodiments, wherein the features presented below may in each case individually or in combination constitute an aspect of the invention. In the drawings:

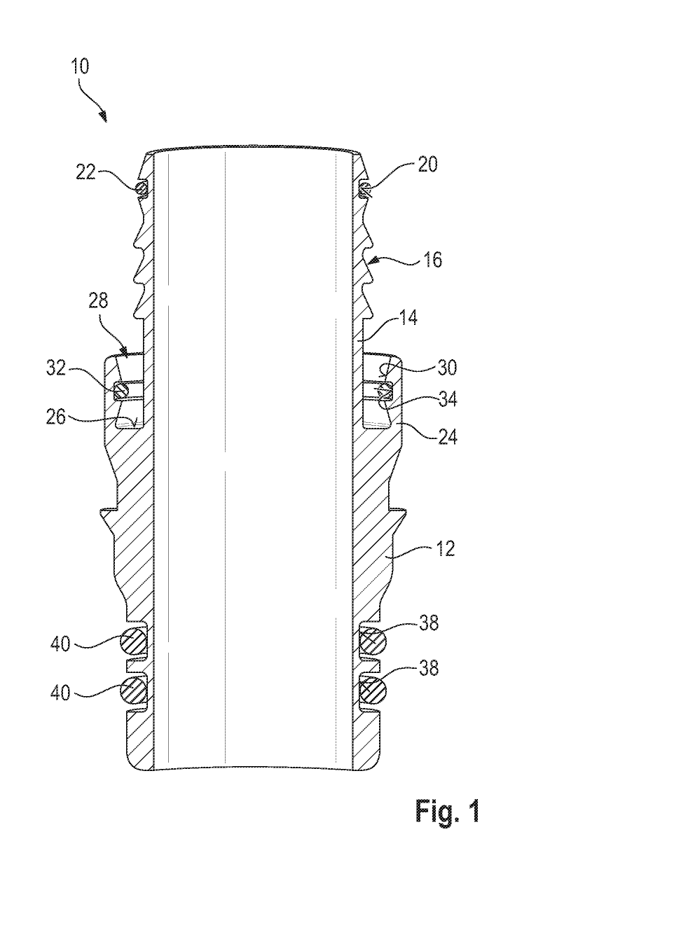

The pipe connector 10 shown in FIG. 1 has a metallic coupling element 12, which is made for example of steel, in particular a stainless steel. The coupling element 12 has a projecting pipe projection 14 which, by means of a latching profile 16 configured as a fir-tree profile, can be connected to a tubular fuel line 18 made of PE, for example by the harder latching profile 16 digging into the softer material of the fuel line 18. At the free end of the pipe projection 14 there is provided a circumferential sealing groove 20 which is open radially outward and in which is inserted an inner sealing element 22, in the form of an O-ring, in order to seal the fuel line 18 with respect to the pipe projection 14.

A retaining collar 24 of the coupling element 12 is formed essentially coaxially with the pipe projection 14, the axial extent of said collar being markedly smaller than the axial extent of the pipe projection 14. The retaining collar 24 and the pipe projection 14 form, together with an end stop 26 connecting the retaining collar 24 to the pipe projection 14, a receiving pocket 28 into which the fuel line 18 can be inserted via an insertion chamfer 30 formed from the retaining collar 24. The axial extent of the retaining collar 24 and the radial distance between the retaining collar 24 and the pipe projection 14 is chosen such that swelling of the fuel line 18 can be blocked by the retaining collar 24 before an adequate sealing effect between the pipe projection 14 and the fuel line 18 is lost. Should the sealing effect of the inner sealing element 20 be inadequate when the fuel line 18 is in the swollen state, an adequate sealing effect is provided at least in the region of the retaining collar 24. To that end, the retaining collar 24 can have an outer sealing element 32, in the form of an O-ring, which bears against the outer side of the fuel line and is inserted in a circumferential receiving groove 34, open radially inward, of the retaining collar 24. The minimum internal diameter of the retaining collar 24 can be formed by the outer sealing element 32.

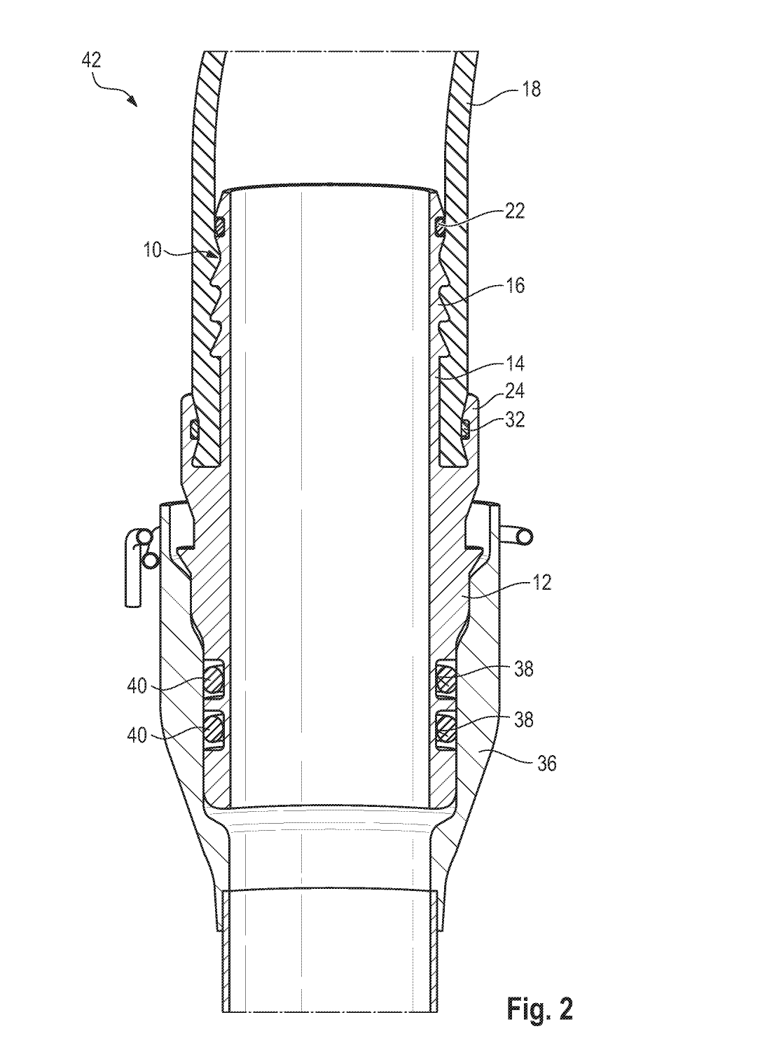

As shown in the pipe connection system 42 illustrated in FIG. 2, the retaining collar 24, in particular the outer sealing element 32 of the retaining collar 24, can dig into the material of the swollen fuel line 18 to a certain extent, thus achieving a good seal and an assembly which is difficult to undo. In addition, the coupling element 12 can be connected, at the opposite end from the fuel line 18, to another fuel line 36 of a fuel supply for an internal combustion engine of a motor vehicle. To that end, the coupling element 12 can for example be inserted into the other fuel line 36. To that end, the coupling element 12 can have at least one circumferential groove 38 in each of which is inserted another sealing element 40, for example in the form of an O-ring, of the pipe connector 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A pipe connector for connecting a fuel line of a fuel supply for a motor vehicle engine of a motor vehicle, the pipe connector comprising:
a coupling element comprising a metallic material and configured to connect to the fuel line, the fuel line comprising a synthetic material, the coupling element comprising:
a pipe projection configured for clamping insertion into the fuel line, and
a retaining collar for radially externally surrounding the fuel line, an extent of the retaining collar in an axial direction and a distance between the retaining collar and pipe projection being selected so as to limit swelling of the fuel line.

2. The pipe connector as recited in claim 1, wherein the retaining collar comprises, facing the pipe projection, a deformable outer sealing element configured to bear against a radially outer side of the fuel line.

3. The pipe connector as recited in claim 2, wherein the deformable outer sealing element is formed as a sealing ring.

4. The pipe connector as recited in claim 2, wherein the retaining collar includes a circumferential receiving groove, which is open towards the pipe projection, for receiving the outer sealing element.

5. The pipe connector as recited in claim 2, wherein the outer sealing element forms the smallest internal diameter of the retaining collar.

6. The pipe connector as recited in claim 1, wherein the retaining collar includes an insertion chamfer for inserting the fuel line between the pipe projection and the retaining collar.

7. The pipe connector as recited in claim 1, wherein the pipe projection has a radially outward-facing latching profile for embedding into the material of the fuel line.

8. The pipe connector as recited in claim 7, wherein the radially outward-facing latching profile is configured as a fir-tree profile.

9. The pipe connector as recited in claim 7, wherein the latching profile is formed offset in the axial direction with respect to a part region of the pipe projection that is overlapped in the radial direction by the retaining collar.

10. The pipe connector as recited in claim 1, wherein the pipe projection includes, facing the retaining collar, a deformable inner sealing element for bearing against a radially inner side of the fuel line.

11. The pipe connector as recited in claim 10, wherein the deformable inner sealing element is formed as a sealing ring.

12. A pipe connection system for the fuel supply of a motor vehicle engine, the pipe connection system comprising:
a fuel line comprising a polyolefin; and
a coupling element comprising a metallic material that is connected to the fuel line, the coupling element comprising:
a pipe projection inserted into the fuel line, and
a retaining collar radially externally surrounding the fuel line, an extent of the retaining collar in an axial direction and a distance between the retaining collar and pipe projection being selected so as to limit swelling of the fuel line.

13. The pipe connection system as recited in claim 12, wherein the polyolefin is polyethylene.

14. The pipe connection system as recited in claim 12, wherein the retaining collar is partially embedded in the material of the fuel line.

15. The pipe connection system as recited in claim 14, wherein the retaining collar comprises, facing the pipe projection, a deformable outer sealing element that bears against a radially outer side of the fuel line.

16. The pipe connection system as recited in claim 15, wherein the outer sealing element is partially embedded in the material of the fuel line.
